(19) United States
(12) Patent Application Publication
(10) Pub. No.: US 2026/0149068 A1
(43) Pub. Date: May 28, 2026

(54) FORMATION METHOD FOR SECONDARY BATTERY, AND SECONDARY BATTERY FORMED THEREBY

(71) Applicants: Hyundai Motor Company, Seoul (KR); Kia Corporation, Seoul (KR)

(72) Inventors: Yeji SON, Hwaseong-Si (KR); YOUNGWOO LEE, Hwaseong-Si (KR); Yoon Ji LEE, Hwaseong-Si (KR); SungHoon LIM, Hwaseong-Si (KR)

(21) Appl. No.: 19/220,309

(22) Filed: May 28, 2025

(30) Foreign Application Priority Data
Nov. 28, 2024 (KR) 10-2024-0173761

(51) Int. Cl. H01M 10/44; H01M 4/38; H01M 10/0525; H01M 10/058

(52) U.S. Cl. CPC H01M 10/445; H01M 4/386; H01M 10/0525; H01M 10/058; H01M 10/443

(57) ABSTRACT

A formation method for a secondary battery with an anode reversible capacity of 400 mAh/g or more may include: charging the secondary battery to a first state of charge (SOC) of 3 to 10% at a rate of 0.1 to 0.5 C; charging the secondary battery from the first SOC to a second SOC of 20 to 40% at a rate of 0.3 to 1.8 C; charging the secondary battery, from the second SOC to a third SOC of 100% at a rate of 0.05 to 1.8 C; and discharging the secondary battery from the third SOC. At least one of the charging to the first SOC, the second SOC or the third SOC or the discharging may be performed under a pressure condition exceeding 800 kgf/cm³ and less than or equal to 2000 kgf/cm³ and/or at a temperature condition of 30 to 70° C.

### CROSS-REFERENCE TO RELATED APPLICATION

This present application claims the benefit of priority to Korean Patent Application No. 10-2024-0173761, filed on Nov. 28, 2024 in the Korean Intellectual Property Office, the entire disclosure of which is incorporated herein by reference.

### FIELD

The present disclosure relates to a formation method for a secondary battery and a secondary battery formed thereby.

### BACKGROUND

With the rapid development of the electronic, communication, and computer industries, energy storage technology applications are expanding to camcorders, mobile phones, laptops, personal computers (PCs), and even electric vehicles, among others. Lightweight, long-lasting, and highly reliable high-performance secondary batteries are desirable for such applications.

Among the secondary batteries currently in use, lithium-ion batteries developed in the early 1990s have higher operating voltage and energy density than conventional batteries such as Ni-MH, Ni—Cd, and lead-sulfur batteries that use aqueous electrolyte solutions. As such, lithium-ion batterys have been adopted as power sources for many portable devices.

Materials including graphite have been widely used as an anode active material of the lithium-ion battery. Since the average potential when graphite absorbs/releases lithium is approximately 0.1 to 0.2 V (based on Li/Li+) and the discharge potential is relatively flat, there is an advantage in that the voltage of a battery using graphite is high and constant. However, there is a disadvantage in that graphite has a very small theoretical capacity of 372 mAh/g.

Therefore, various anode active materials are being studied to further increase the capacity of lithium-ion batteries. As a high-capacity anode active material, materials that form intermetallic compounds with lithium, such as silicon or tin, are expected to be promising anode active materials. In particular, silicon is an alloy-type anode active material with a theoretical capacity (4,200 mAh/g) that is about 10 times higher than that of graphite and is attracting attention as a next-generation anode active material.

In general, after the secondary battery is manufactured, a formation process is performed in which some charging and discharging is performed. The battery structure becomes stabilized and usable via the formation process. The formation process forms a solid electrolyte interface (hereinafter referred to as ‘SEI film’) on the electrode (specifically, anode) to stabilize the structure of the electrode. However, silicon-based anode active materials undergo a large volume change (about 300%) during charging and discharging, so physical contact between active materials may be broken and fragmentation may occur. As a result, ion conductivity and electrical conductivity deteriorate rapidly, and life characteristics tend to decrease rapidly.

Therefore, in a secondary battery having a high reversible capacity using a silicon-based material as an anode active material, there is a need for technology development for an improved formation process that can shorten a process time while securing cell performance.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a formation method for a secondary battery. A formation method for a secondary battery with an anode reversible capacity of at least 400 mAh/g may comprise: charging the secondary battery to a first state of charge (SOC) of 3 to 10% at a first rate of 0.1 to 0.5 C; charging the secondary battery from the first SOC to a second SOC of 20 to 40% at a second rate of 0.3 to 1.8 C; charging the secondary battery from the second SOC to a third SOC of 100% at a third rate of 0.05 to 1.8 C; and discharging the secondary battery charged to the third SOC.

A formation method for a secondary battery may comprise at least one of: charging the secondary battery at a pressure exceeding 800 kgf/cm³ and less than or equal to 2000 kgf/cm³; or discharging the secondary battery at a pressure exceeding 800 kgf/cm³ and less than or equal to 2000 kgf/cm³.

A formation method for a secondary battery may comprise charging the secondary battery at a temperature of 30 to 70° C.; or discharging the secondary battery at a temperature of 30 to 70° C.

A secondary battery may be formed/prepared using any one or more of the formation methods disclosed herein.

These and other features and advantages are described in greater detail below.

### BRIEF DESCRIPTION OF THE DRAWINGS

The foregoing and other embodiments, features, and advantages of the disclosure, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements.

FIG. 1 is a process flowchart of a formation method for a secondary battery according to an example of the present disclosure.

FIG. 2 is a process flowchart of a formation method for a secondary battery according to an example of the present disclosure.

FIG. 3 is a process flowchart of a formation method for a secondary battery according to an example of the present disclosure.

FIG. 4 is a schematic diagram for a secondary battery according to an example of the present disclosure.

### DETAILED DESCRIPTION

Hereinafter, examples disclosed in the present specification will be described in detail. In the following description, redundant descriptions of identical or similar components may be omitted.

Unless otherwise defined, the terms used herein, including technical or scientific terms, may have meanings generally understood by those skilled in the art to which the present disclosure belongs.

In the present specification, the terms “include”, “comprise” or “have” indicate the presence of features, numbers, steps, operations, components, parts, or combinations thereof described in the specification, but do not exclude in advance any of the features, numbers, steps, operations, components, parts, or combinations thereof.

A singular expression used herein may include the meaning of the plural unless otherwise stated in the context, which also applies to the singular expression described in the claims.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method. Values and ranges disclosed herein may include the exact values and also, or alternatively, about the disclosed value.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

A formation method for a secondary battery according to an example of the present disclosure relates to a formation method for a secondary battery having an anode reversible capacity of 400 mAh/g or more. The formation method for a secondary battery according to an example of the present disclosure may target a secondary battery having an anode reversible capacity of 400 mAh/g to 600 mAh/g. The formation method for a secondary battery according to an example of the present disclosure may target a secondary battery having an anode reversible capacity of 400 mAh/g to 570 mAh/g. The formation method for a secondary battery according to an example of the present disclosure may target a secondary battery comprising a silicon-based material as an anode active material.

The formation method for a secondary battery may comprise a first formation step, a second formation step, a third formation step, and a discharging step.

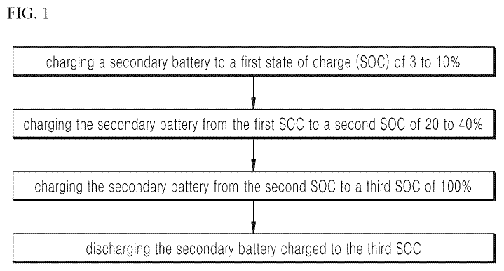

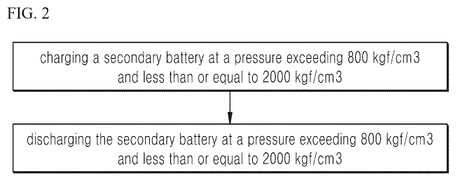

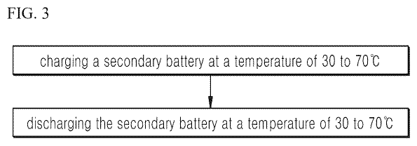

FIG. 1 is a process flowchart of a formation method for a secondary battery according to an example of the present disclosure. FIG. 2 is a process flowchart of a formation method for a secondary battery according to an example of the present disclosure. FIG. 3 is a process flowchart of a formation method for a secondary battery according to an example of the present disclosure.

Referring to FIG. 1, a formation method for a secondary battery with an anode reversible capacity of at least 400 mAh/g may comprise: charging the secondary battery to a first state of charge (SOC) of 3 to 10% at a first rate of 0.1 to 0.5 C; charging the secondary battery from the first SOC to a second SOC of 20 to 40% at a second rate of 0.3 to 1.8 C; charging the secondary battery from the second SOC to a third SOC of 100% at a third rate of 0.05 to 1.8 C; and discharging the secondary battery charged to the third SOC.

Referring to FIG. 2, a formation method for a secondary battery may comprise at least one of: charging the secondary battery at a pressure exceeding 800 kgf/cm³ and less than or equal to 2000 kgf/cm³; or discharging the secondary battery at a pressure exceeding 800 kgf/cm³ and less than or equal to 2000 kgf/cm³.

Referring to FIG. 3, a formation method for a secondary battery may comprise charging the secondary battery at a temperature of 30 to 70° C.; or discharging the secondary battery at a temperature of 30 to 70° C.

The first formation step may comprise charging a secondary battery to a first state of charge (SOC) of 3 to 10% at a first rate of 0.1 to 0.5 C (C-rate; where 1 C means a rate at which the battery will charge from zero to capacity in one hour, 0.1 C means a rate at which the battery will charge from zero to capacity in 10 hours, etc.). The first formation step may comprise charging the secondary battery to a first SOC of 3 to 8% at a first rate of 0.1 to 0.4 C. The first formation step may comprise charging the secondary battery to a first SOC of 3 to 7% at a first rate of 0.1 to 0.3 C. The first formation step may comprise charging a secondary battery to a first SOC of 3 to 6% at a first rate of 0.1 to 0.2 C. The first formation step may comprise charging the secondary battery to a first SOC of 4 to 6% at a first rate of 0.1 to 0.2 C. The first formation step may comprise charging the secondary battery to a SOC of 5% at a rate of 0.1 to 0.2 C.

The first formation step may be performed under high-temperature pressurization conditions. The first formation step may be performed under a pressure condition exceeding 800 kgf/cm³ and less than or equal to 2000 kgf/cm³. The first formation step may be performed under a pressure condition of 800 kgf/cm³ to 1800 kgf/cm³. The first formation step may be performed under a pressure condition of 1000 kgf/cm³ to 1800 kgf/cm³. The first formation step may be performed under a temperature condition of 30 to 70° C. The first formation step may be performed under a temperature condition of 40 to 65° C. The first formation step may be performed under a temperature condition of 45 to 60° C.

The second formation step may comprise charging the secondary battery, charged to the first SOC, to a second SOC of 20 to 40% at a second rate of 0.3 to 1.8 C. The second formation step may comprise charging the secondary battery to a second SOC of 20 to 40% at a second rate of 0.4 to 1.7 C. The second formation step may comprise charging the secondary battery to a second SOC of 20 to 40% at a second rate of 0.5 to 1.5 C. The second formation step may comprise charging the secondary battery to a second SOC of 25 to 35% at a second rate of 0.5 to 1.5 C. The second formation step may comprise charging the secondary battery to a second SOC of 30% at a second rate (C-rate) of 0.5 to 1.5 C.

The second formation step may be performed at once to a target SOC (e.g., the second SOC). Also, or alternatively, the second formation step may be performed in multiple steps. The second formation step may be performed 1 to 5 times from the first SOC to the target SOC (e.g., performed in 1 to 5 charging periods from the first SOC up to the second SOC). The second formation step may be performed 1 to 3 times from the first SOC to the target SOC. For example, if the first formation step is performed to a first SOC of 5% and the second SOC of the second formation step is 30%, the process may be performed by being divided into a section for charging to a SOC of 5 to 10%, a section for charging to a SOC of 10 to 20%, and a section for charging to a SOC of 20 to 30%. There may be a pause in charging between each section and/or rates of the sections may change between sections. The rates of each section may be the same or different from each other. When the rates of each section are different, the rate of the last section may be the highest. Each rate may be within the second rate ranges above.

The second formation step may be performed under high-temperature pressurization conditions. The second formation step may be performed under a pressure condition exceeding 800 kgf/cm³ and less than or equal to 2000 kgf/cm³. The second formation step may be performed under a pressure condition of 800 kgf/cm³ to 1800 kgf/cm³. The second formation step may be performed under a pressure condition of 1000 kgf/cm³ to 1800 kgf/cm³. The second formation step may be performed under a temperature condition of 30 to 70° C. The second formation step may be performed under a temperature condition of 40 to 65° C. The second formation step may be performed under a temperature condition of 45 to 60° C.

The third formation step may comprise charging the secondary battery, charged to the second SOC, to a third SOC of 100% at a third rate of 0.05 to 1.8 C. The third formation step may comprise charging the secondary battery to a third SOC of 100% at a third rate (C-rate) of 0.1 to 1.7 C. The third formation step may comprise charging the secondary battery to a third SOC of 100% at a third rate of 0.1 to 1.6 C. The third formation step may comprise charging the secondary battery to a third SOC of 100% at a third rate of 0.1 to 1.5 C.

A maximum rate of the third formation step may be 0.4 to 1.7 C (e.g., a maximum value of the third rate at which the battery is charged during the third formation step). The maximum rate of the third formation step may be 0.5 to 1.6 C. The maximum rate of the third formation step may be 0.5 to 1.6 C. The maximum rate of the third formation step may be 0.5 to 1.5 C.

The third formation step may be performed under the high-temperature pressurization conditions. The third formation step may be performed under a pressure condition exceeding 800 kgf/cm³ and less than or equal to 2000 kgf/cm³. The third formation step may be performed under a pressure condition of 800 kgf/cm³ to 1800 kgf/cm³. The third formation step may be performed under a pressure condition of 1000 kgf/cm³ to 1800 kgf/cm³. The third formation step may be performed under a temperature condition of 30 to 70° C. The third formation step may be performed under a temperature condition of 40 to 65° C. The third formation step may be performed under a temperature condition of 45 to 60° C.

The discharging step may comprise discharging the secondary battery from the third SOC. The discharging step may be performed at a discharging rate (C-rate, where 1 C corresponds to rate of discharge that would result in a complete discharge of the battery from 100% SOC to 0% SOC in one hour). The discharging step may comprise discharging to a SOC of 0 to 70% at a rate of 0.05 to 1.8 C. The discharging step may comprise discharging to a SOC of 0 to 70% at a rate of 0.1 to 1.7 C. The discharging step may comprise discharging to a SOC of 0 to 70% at a rate of 0.1 to 1.6 C. The discharging step may comprise discharging to a SOC of 0 to 70% at a rate of 0.1 to 1.5 C. The discharging step may comprise discharging to a SOC of 30 to 70% at a rate of 0.05 to 1.8 C. The discharging step may comprise discharging to a SOC of 40 to 70% at a rate of 0.1 to 1.7 C. The discharging step may comprise discharging to a SOC of 50 to 70% at a rate of 0.1 to 1.6 C. The discharging step may comprise discharging to a SOC of 60% at a rate of 0.1 to 1.5 C.

The rate of the discharging step (e.g., discharging rate) may be equal to the maximum rate in the third formation step. For example, the rate of the discharging step may be 0.4 to 1.7 C. The rate of the discharging step may be 0.5 to 1.6 C. The rate of the discharging step may be 0.5 to 1.6 C. The rate of the discharging step may be 0.5 to 1.5 C.

The discharging step may be performed under the high-temperature pressurization conditions. The discharging step may be performed under a pressure condition exceeding 800 kgf/cm³ and less than or equal to 2000 kgf/cm³. The discharging step may be performed under a pressure condition exceeding 800 kgf/cm³ and less than or equal to 1800 kgf/cm³. The discharging step may be performed under a pressure condition exceeding 1000 kgf/cm³ and less than or equal to 1800 kgf/cm³. The discharging step may be performed under a temperature condition of 30 to 70° C. The discharging step may be performed under a temperature condition of 40 to 65° C. The discharging step may be performed under a temperature condition of 45 to 60° C.

The formation method for a secondary battery according to an example of the present disclosure may not include an initial formation step of charging to a fourth SOC of less than 3% at a fourth rate. That is, the formation method for a secondary battery according to an example of the present disclosure may not include another formation step before the first formation step. The formation method for a secondary battery according to an example of the present disclosure may omit an initial formation step. According to the formation method for a secondary battery according to one example of the present disclosure, it is possible to secure excellent cell performance while reducing the process time, for example, by omitting the initial formation step.

The formation method for a secondary battery according to an example of the present disclosure may reduce the volume expansion of the anode. The formation method for a second battery as disclosed herein may form a dense interface when applied to the secondary battery having the anode reversible capacity of 400 mAh/g or more. According to the formation method for a secondary battery according to an example of the present disclosure, it may be possible to improve the cell appearance and/or durability of the secondary battery having the anode reversible capacity of 400 mAh/g or more. According to the formation method for a secondary battery according to an example of the present disclosure, it is possible to secure the cell performance of the secondary battery having the anode reversible capacity of 400 mAh/g or more.

The formation method for a secondary battery according to an example of the present disclosure may reduce the volume expansion of the anode and form the dense interface when applied to the secondary battery comprise the silicon-based material as the anode active material. According to the formation method for a secondary battery according to an example of the present disclosure, it is possible to improve the cell appearance and durability of the secondary battery comprise the silicon-based material as the anode active material. According to the formation method for a secondary battery according to an example of the present disclosure, it is possible to secure the cell performance of the secondary battery comprise the silicon-based material as the anode active material. According to the formation method for a secondary battery according to an example of the present disclosure, it is possible to suppress the initial volume expansion of silicon and increase the uniformity of the electrode interface.

According to the formation method for a secondary battery according to an example of the present disclosure, it is possible to drastically reduce the process time, making it advantageous for mass production of the secondary battery.

The secondary battery according to an example of the present disclosure may be formed by the formation method described herein.

The anode of the secondary battery according to various examples of the present disclosure may comprise silicon (Si) as an anode active material. Si may make up 5 to 15 wt % of a total composition of the anode. The anode of the secondary battery according to various examples of the present disclosure may further comprise graphite as an anode active material. The anode of the secondary battery according to various examples of the present disclosure may comprise at least one additional anode active material to graphite (e.g., not comprise only graphite as the anode active material).

The anode of the secondary battery according to various examples of the present disclosure may further comprise a conductive material, a binder, and/or a thickener.

The conductive material may comprise at least any one selected from the group consisting of natural graphite, artificial graphite, carbon black, acetylene black, Ketjen black, channel black, paneth black, lamp black, thermal black, conductive fiber, fluorocarbon, aluminum powder, nickel powder, zinc oxide, potassium titanate, titanium oxide, polyphenylene derivatives, carbon nanotube, plate-like graphite, graphene, graphene oxide, and graphite flake.

The binder and/or thickener may each independently comprise at least any one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butadiene rubber (SBR), fluoroelastomer, and poly acrylic acid, and may also comprise various copolymers thereof.

The secondary battery according to various examples of the present disclosure may comprise a cathode. The cathode may comprise a cathode active material, a conductive material, and a binder. The cathode active material may comprise at least any one selected from the group consisting of, for example, nickel cobalt manganese (NCM), nickel cobalt aluminum (NCA), lithium manganese oxide (LMO), lithium cobalt oxide (LCO), and lithium iron phosphate (LFP). Preferably, the cathode active material may comprise NCM.

The conductive material may comprise at least any one selected from the group consisting of natural graphite, artificial graphite, carbon black, acetylene black, Ketjen black, channel black, paneth black, lamp black, thermal black, conductive fiber, fluorocarbon, aluminum powder, nickel powder, zinc oxide, potassium titanate, titanium oxide, polyphenylene derivatives, carbon nanotube, plate-like graphite, graphene, graphene oxide, and graphite flake.

The binder may comprise at least any one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butadiene rubber (SBR), fluoroelastomer, and poly acrylic acid. The binder may also or alternatively comprise various copolymers of the above group.

The secondary battery according to various examples of the present disclosure may comprise a separator and an electrolyte between the cathode and the anode.

The separator may separate the anode and the cathode and provide a passage through which lithium ions may move. The separator may comprise a porous polymer film, for example, a porous polymer film made of a polyolefin-based polymer such as any one or more of an ethylene homopolymer, a propylene homopolymer, an ethylene/butene copolymer, an ethylene/hexene copolymer, and an ethylene/methacrylate copolymer, or a laminated structure of two or more layers thereof. Also, or alternatively, the separator may comprise a nonwoven fabric made of high-melting-point glass fibers, polyethylene terephthalate fibers, and/or the like.

The electrolyte may comprise an organic liquid electrolyte, an inorganic liquid electrolyte, a solid polymer electrolyte, a gel-type polymer electrolyte, a solid inorganic electrolyte, a molten inorganic electrolyte, and/or the like.

The secondary battery according to various examples of the present disclosure may secure excellent performance by applying the optimized formation process for the secondary battery comprising the silicon-based material as the anode active material.

### Manufacturing Example: Manufacturing of Secondary Battery

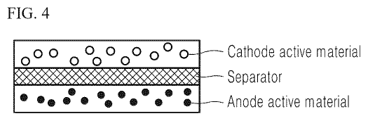

FIG. 4 is a schematic diagram for a secondary battery according to an example of the present disclosure. Referring to FIG. 4, a cathode comprising an NCM cathode active material and an anode comprising a Si anode active material were prepared. Examples were prepared, where the anode as prepared had an anode reversible capacity of 405 mAh/g, 484 mAh/g, and 561 mAh/g by adjusting an Si content. An electrode assembly was manufactured by interposing a separator between the cathode and the anode, and the electrode assembly was inserted into a battery case and then an electrolyte solution was injected to manufacture a secondary battery.

### Experimental Example 1: Confirmation of Process Time and Cell Performance According to High-Temperature Pressurization Process

A formation process was performed on a lithium secondary battery having an anode reversible capacity of 405 mAh/g manufactured in the Manufacturing Example.

Comparative Example 1 additionally included an initial formation step of charging to less than a SOC of 3%, and the third formation step of charging to a SOC of 100% was performed using a room temperature, non-pressurized (e.g., atmospheric pressure) process instead of the high-temperature pressurization process.

Comparative Example 2 performed a discharging step using the room temperature, non-pressurized process instead of the high-temperature pressurization process.

Comparative Example 3 additionally performed the initial formation step of charging to less than a SOC of 3%, performed the first and second formation steps at 5 kgf/cm³, and performed a third formation step of charging to a SOC of 100% using the room temperature, non-pressurized process instead of the high-temperature pressurization process.

Comparative Example 4 performed the second formation step using the room temperature, non-pressurized process instead of the high-temperature pressurization process.

That is, Example 1 did not include the initial formation step of charging to less than a fourth SOC of 3%, and applied the high-temperature pressurization process of 45° C. and 1800 kgf/cm³ to all of the first formation step, the second formation step, the third formation step, and the discharging step.

Meanwhile, the SOC, C-rate, temperature, and pressure conditions of each formation step are shown in Table 1 below.

TABLE 1

| | | | | | | High-temperature |
|---|---|---|---|---|---|---|
| | | SOC | C-rate | Temperature | Pressure | pressurization (◯) |
| No. | Step division | (%) | (C) | (° C.) | (kgf/cm³) | or not (X) |
| Com. | Initial formation step | 0.3 | 0.05 | Room | 0 | X |
| Ex. 1 | | | | Temperature | | |
| | First formation step | 5 | 0.15 | 45 | 1800 | ◯ |
| | Second formation | 25.3 | 0.4 | 45 | 1800 | ◯ |
| | step | | | | | |
| | Third formation step | 100 | 0.3 | Room | 0 | X |
| | | | | Temperature | | |
| | | 100 | 0.1 | Room | 0 | X |
| | | | | Temperature | | |
| | Discharging step | 0 | 0.5 | Room | 0 | X |
| | | | | Temperature | | |
| Com. | First formation step | 5 | 0.2 | 45 | 1800 | ◯ |
| Ex. 2 | Second formation | 30 | 1.5 | 45 | 1800 | ◯ |
| | step | | | | | |
| | Third formation step | 100 | 1.5 | 45 | 1800 | ◯ |
| | | 100 | 0.1 | 45 | 1800 | ◯ |
| | Discharging step | 60 | 0.5 | Room | 0 | X |
| | | | | Temperature | | |
| Com. | Initial formation step | 0.3 | 0.05 | Room | 0 | X |
| Ex. 3 | | | | Temperature | | |
| | First formation step | 5 | 0.15 | 45 | 5 | ◯ |
| | Second formation | 30 | 0.4 | 45 | 5 | ◯ |
| | step | | | | | |
| | Third formation step | 100 | 0.3 | Room | 0 | X |
| | | | | Temperature | | |
| | | 100 | 0.1 | Room | 0 | X |
| | | | | Temperature | | |
| | Discharging step | 0 | 0.5 | Room | 0 | X |
| | | | | Temperature | | |
| Com. | First formation step | 5 | 0.2 | 45 | 1800 | ◯ |
| Ex. 4 | Second formation | 60 | 0.1 | Room | 0 | X |
| | step | | | Temperature | | |
| | Third formation step | 100 | 1.5 | 45 | 1800 | ◯ |
| | | 100 | 0.1 | 45 | 1800 | ◯ |
| | Discharging step | 60 | 1 | 45 | 1800 | ◯ |
| Ex. 1 | First formation step | 5 | 0.2 | 45 | 1800 | ◯ |
| | Second formation | 30 | 0.5 | 45 | 1800 | ◯ |
| | step | | | | | |
| | Third formation step | 100 | 1 | 45 | 1800 | ◯ |
| | | 100 | 0.1 | 45 | 1800 | ◯ |
| | Discharging step | 60 | 1 | 45 | 1800 | ◯ |

The results of confirming the total formation process time, the maximum power discharge (15 s, SOC40), maximum power charge (15 s, SOC70), the power density discharge (15 s, SOC40), and the power density charge (15 s, SOC40) for the above Comparative Examples 1 to 4 and Example 1 are as shown in Table 2 below.

TABLE 2

| | | Maximum | Maximum | Power | Power |
|---|---|---|---|---|---|
| | | power | power | density | density |
| | | discharge | charge | discharge | charge |
| | Process | (15 s, | (15 s, | (15 s, | (15 s, |
| | time | SOC40) | SOC70) | SOC40) | SOC40) |
| No. | (min) | (W) | (W) | (W) | (W) |
| Com. | 2616 | 2203.50 | 1414.00 | 2865.50 | 1838.50 |
| Ex. 1 | | | | | |
| Com. | 255 | 2241.00 | 1452.50 | 2912.00 | 1887.50 |
| Ex. 2 | | | | | |
| Com. | 2566 | 2204.50 | 1443.50 | 2865.00 | 1875.50 |
| Ex. 3 | | | | | |
| Com. | 2699 | 2199.50 | 1434.50 | 2858.00 | 1864.00 |
| Ex. 4 | | | | | |
| Ex. 1 | 265 | 2254.00 | 1468.00 | 2929.00 | 1907.50 |

Referring to Table 2 above, it was confirmed that the process time of Example 1 was reduced by 10× compared to Comparative Examples 1, 3, and 4.

In addition, it was confirmed that the values of the maximum power discharge (15 s, SOC40), the maximum power charge (15 s, SOC70), the power density discharge (15 s, SOC40), and the power density charge (15 s, SOC40) of Example 1 were superior to those of Comparative Examples 1 to 4. That is, it could be seen that the output value and durability performance of Example 1 were superior to any of the comparative examples.

Therefore, the initial formation step of charging to less than a SOC of 3% is not included, and it was confirmed that the cell performance was superior when the high-temperature pressurization process of 45° C. and 1800 kgf/cm³ was applied to all of the first formation step, the second formation step, the third formation step, and the discharging step.

### Experimental Example 2: Confirmation of Cell Performance According to Changes in C-Rate and Temperature

A formation process was performed on a lithium secondary battery having an anode reversible capacity of 484 mAh/g manufactured in the Manufacturing Example. It was confirmed through the above Experimental Example 1 that the cell performance was superior when the high-temperature pressurization process of 45° C. and 1800 kgf/cm³ was applied to all of the first formation step, the second formation step, the third formation step, and the discharging step. In this Experimental Example, the cell performance was confirmed by changing the C-rate and temperature of each step. In this Experimental Example, the conditions under which the excellent cell performance may be secured even if the process time was shortened by changing the C-rate and temperature were confirmed.

Example 2 changed only the temperature from the above Example 1. That is, Example 2 was performed in the same manner as Example 1 except that the temperature was increased to 60° C.

Example 3 changed the C-rate and temperature from the above Example 1. That is, Example 3 was conducted by lowering the C-rate of the first formation step from 0.2 C to 0.1 C in the above Example 1, subdividing the second formation step to add a section with a C-rate of 1.5 C, increasing the C-rate of the third formation step and the discharging step to 1.5 C, and increasing the temperature to 60° C.

Example 4 was conducted by only changing the C-rate of the above Example 1. That is, Example 4 was conducted by subdividing the second formation step of the above Example 1 to add a section with a C-rate of 1.5 C, and increasing the C-rate of the third formation step and the discharging step to 1.5 C.

Example 5 was conducted by only changing the C-rate of the above Example 1. That is, Example 5 was conducted by lowering the C-rate of the first formation step from 0.2 C to 0.1 C in the above Example 1, subdividing the second formation step to add a section with a C-rate of 0.33 C and 1.5 C, and increasing the C-rate of the third formation step and the discharging step to 1.5 C.

Example 6 changed the C-rate and temperature from the above Example 1. That is, Example 6 was conducted by subdividing the second formation step of the above Example 1 to add a section with a C-rate of 1.5 C, increasing the C-rate of the third formation step and the discharging step to 1.5 C, and increasing the temperature to 60° C.

Example 7 was conducted by only changing the C-rate of the above Example 1. That is, Example 7 was conducted by lowering the C-rate of the first formation step from 0.2 C to 0.1 C in the above Example 1, subdividing the second formation step to add a section with a C-rate of 1.5 C, and increasing the C-rate of the third formation step and the discharging step to 1.5 C.

The SOC, C-rate, temperature, and pressure conditions of each formation step are shown in Table 3 below.

TABLE 3

| | Step | SOC | C-rate | Temperature | Pressure |
|---|---|---|---|---|---|
| No. | division | (%) | (C) | (° C.) | (kgf/cm³) |
| Ex. 2 | First formation step | 5 | 0.2 | 60 | 1800 |
| | Second formation step | 30 | 0.5 | 60 | 1800 |
| | Third formation step | 100 | 1 | 60 | 1800 |
| | | 100 | 0.1 | 60 | 1800 |
| | Discharging step | 60 | 1 | 60 | 1800 |
| Ex. 3 | First formation step | 5 | 0.1 | 60 | 1800 |
| | Second formation step | 10 | 0.5 | 60 | 1800 |
| | | 20 | 0.5 | 60 | 1800 |
| | | 30 | 1.5 | 60 | 1800 |
| | Third formation step | 100 | 1.5 | 60 | 1800 |
| | Discharging step | 60 | 1.5 | 60 | 1800 |
| Ex. 4 | First formation step | 5 | 0.2 | 45 | 1800 |
| | Second formation step | 10 | 0.5 | 45 | 1800 |
| | | 20 | 0.5 | 45 | 1800 |
| | | 30 | 1.5 | 45 | 1800 |
| | Third formation step | 100 | 1.5 | 45 | 1800 |
| | Discharging step | 60 | 1.5 | 45 | 1800 |
| Ex. 5 | First formation step | 5 | 0.1 | 45 | 1800 |
| | Second formation step | 10 | 0.33 | 45 | 1800 |
| | | 20 | 0.5 | 45 | 1800 |
| | | 30 | 1.5 | 45 | 1800 |
| | Third formation step | 100 | 1.5 | 45 | 1800 |
| | Discharging step | 60 | 1.5 | 45 | 1800 |
| Ex. 6 | First formation step | 5 | 0.2 | 60 | 1800 |
| | Second formation step | 10 | 0.5 | 60 | 1800 |
| | | 20 | 0.5 | 60 | 1800 |
| | | 30 | 1.5 | 60 | 1800 |
| | Third formation step | 100 | 1.5 | 60 | 1800 |
| | Discharging step | 60 | 1.5 | 60 | 1800 |
| Ex. 7 | First formation step | 5 | 0.1 | 45 | 1800 |
| | Second formation step | 10 | 0.5 | 45 | 1800 |
| | | 20 | 0.5 | 45 | 1800 |
| | | 30 | 1.5 | 45 | 1800 |
| | Third formation step | 100 | 1.5 | 45 | 1800 |
| | Discharging step | 60 | 1.5 | 45 | 1800 |

The results of confirming the energy density to weight (weight E/D) of the anode, the energy density to volume (volume E/D) of the anode, and the discharge power for the above Examples 2 to 7 are as shown in Table 4 below.

TABLE 4

| | Process | | | Room temperature | Low temperature | Discharge |
|---|---|---|---|---|---|---|
| | time | Weight E/D | Volume E/D | resistance | resistance | power |
| No. | (min) | (Min. Wh/Kg) | (Min. Wh/L) | (Ω) | (Ω) | (W) |
| Ex. 2 | 142 | 300 | 673 | 1.00 | 4.95 | 2452 |
| Ex. 3 | 108 | 300 | 679 | 1.05 | 5.00 | 2395 |
| Ex. 4 | 93 | 302 | 677.2 | 1.06 | 4.96 | 2397 |
| Ex. 5 | 111 | 303 | 682.2 | 1.01 | 4.71 | 2414 |
| Ex. 6 | 93 | 302 | 676.5 | 1.04 | 4.82 | 2368 |
| Ex. 7 | 96 | 304 | 685.5 | 1.00 | 4.86 | 2449 |

In the case of Example 2, it can be seen that when the temperature is increased to 60° C., the discharge power is the best, but the process time is the most disadvantageous.

In order to reduce the process time while proceeding at 60° C. and increase the rate of the C-rate of the second formation step, the third formation step, and the discharging step, and maintain the cell performance at the same level, referring to Examples 3 and 6, it was confirmed that it is advantageous to proceed with the first formation step at a rate of 0.1 C.

On the other hand, in the case of Example 7, which proceeded at 45° C., but increased the rate of the C-rate of the second formation step, the third formation step, and the discharging step, it was confirmed that the process time was very short, but the weight E/D and volume E/D were the best compared to the other examples, and the room temperature resistance and discharge power were at the same level as Example 2.

Therefore, when the temperature was 45 and 60° C., it was confirmed that it is advantageous for cell performance to proceed with the first formation step at a low rate of 0.1 C, but the second formation step, third formation step, and discharging step at a high rate of 1.5 C.

### Experimental Example 3: Confirmation of Cell Performance According to Pressure Change

A formation process was performed on a lithium secondary battery having an anode reversible capacity of 561 mAh/g manufactured in the Manufacturing Example. Through the above Experimental Example 2, it was confirmed that Example 7, in which the first formation step, the second formation step, the third formation step, and the discharging step were all performed at a high-temperature pressurization of 45° C. and 1800 kgf/cm³, the C-rate of the first formation step was lowered from 0.2 C to 0.1 C, the second formation step was subdivided to add a section with a C-rate of 1.5 C, and the C-rate of the third formation step and the discharging step was increased to 1.5 C, showed the best performance compared to the process time.

In the present Experimental Example, the cell performance was confirmed by changing the pressure.

Example 8 changed only the pressure from the above Example 7. That is, Example 8 was performed in the same manner as Example 7 except that the pressure was lowered to 1000 kgf/cm³.

Comparative Example 5 changed only the pressure from the above Example 7. That is, Comparative Example 5 was performed in the same manner as Example 7 except that the pressure was lowered to 800 kgf/cm³.

Meanwhile, the SOC, C-rate, temperature, and pressure conditions of each formation step are shown in Table 5 below.

TABLE 5

| | | SOC | c-rate | Temperature | Pressure |
|---|---|---|---|---|---|
| No. | | (%) | (C) | (° C.) | (kgf/cm³) |
| Ex. 7 | First formation step | 5 | 0.1 | 45 | 1800 |
| | Second formation step | 10 | 0.5 | 45 | 1800 |
| | | 20 | 0.5 | 45 | 1800 |
| | | 30 | 1.5 | 45 | 1800 |
| | Third formation step | 100 | 1.5 | 45 | 1800 |
| | Discharging step | 60 | 1.5 | 45 | 1800 |
| Ex. 8 | First formation step | 5 | 0.1 | 45 | 1000 |
| | Second formation step | 10 | 0.5 | 45 | 1000 |
| | | 20 | 0.5 | 45 | 1000 |
| | | 30 | 1.5 | 45 | 1000 |
| | Third formation step | 100 | 1.5 | 45 | 1000 |
| | Discharging step | 60 | 1.5 | 45 | 1000 |
| Com. | First formation step | 5 | 0.1 | 45 | 800 |
| Ex. 5 | Second formation step | 10 | 0.5 | 45 | 800 |
| | | 20 | 0.5 | 45 | 800 |
| | | 30 | 1.5 | 45 | 800 |
| | Third formation step | 100 | 1.5 | 45 | 800 |
| | Discharging step | 60 | 1.5 | 45 | 800 |

The results of confirming the room temperature power performance and low-temperature power performance for the above Examples 7 and 8 and Comparative Example 5 are as shown in Table 6 below.

TABLE 6

| | Room temperature | | Low-temperature | |
|---|---|---|---|---|
| | power performance | | power performance | |
| | | 10-second | | 360-second |
| | 15-second | continuous | 15-second | continuous |
| | discharge | discharge | discharge | discharge |
| | output | power | power | power |
| | (2100 | (2500 | (440 | (150 |
| | W@SOC40) | W@SOC40) | W@SOC20) | W@SOC20) |
| No. | (W) | (W) | (W) | (W) |
| Ex. 7 | 12.3 | 19.6 | 26.4 | 437 |
| Ex. 8 | 12.5 | 20.0 | 23.6 | 419 |
| Com. | 12.0 | 19.1 | 18.8 | 379 |
| Ex. 5 | | | | |

Referring to Table 6 above, it was confirmed that Example 8, in which the pressure was lowered from 1800 kgf/cm³ to 1000 kgf/cm³, showed performance equivalent to Example 7. It was confirmed that in the case of Comparative Example 5, in which the pressure was lowered to 800 kgf/cm³, the room temperature power performance was similar to the Examples, but the low-temperature power performance was significantly reduced. Therefore, it was confirmed that the pressure condition exceeding 800 kgf/cm³ and less than or equal to 1800 kgf/cm³ was the optimal condition.

Through the above Experimental Examples 1 to 3, it was confirmed that if no initial formation step of charging to a fourth SOC less than 3% and if the high-temperature pressurization of 45 to 60° C. and 1000 to 1800 kgf/cm³ is applied to all of the first formation step, the second formation step, the third formation step, and the discharging step, the secondary battery is formed having the anode reversible capacity of 400 mAh/g or more and advantageous cell performance. In particular, it was confirmed that if the first formation step was performed at 0.1 to 0.2 C, but the second formation step, the third formation step, and the discharging step were performed at a high rate of 0.5 to 1.5 C, the process time and cell performance were improved relative to comparative examples.

The examples of the present disclosure are illustrative, and the present disclosure is not limited to the above-described examples.

An aspect of the present disclosure is to provide a formation method for a secondary battery and a secondary battery formed thereby.

According to an example of the present disclosure, a formation method for a secondary battery with an anode reversible capacity of 400 mAh/g or more may comprise: a first formation step of charging the secondary battery to a SOC of 3 to 10% at a rate (C-rate) of 0.1 to 0.5 C; a second formation step of charging the secondary battery, on which the first formation step is performed, to a SOC of 20 to 40% at a rate of 0.3 to 1.8 C; a third formation step of charging the secondary battery, on which the second formation step is performed, to a SOC of 100% at a rate of 0.05 to 1.8 C; and a step of discharging the secondary battery on which the third formation step is performed.

In a formation method for a secondary battery according to an example of the present disclosure, an initial formation step of charging to less than a SOC of 3% may not be included.

In a formation method for a secondary battery according to an example of the present disclosure, the first formation step, the second formation step, the third formation step, and the discharging step may be performed under a pressure condition exceeding 800 kgf/cm³ and less than or equal to 2000 kgf/cm³.

In a formation method for a secondary battery according to an example of the present disclosure, the first formation step, the second formation step, the third formation step, and the discharging step may be performed under a temperature condition of 30 to 70° C.

In a formation method for a secondary battery according to an example of the present disclosure, a C-rate of the discharging step may be the same as a maximum rate in the third formation step.

In a formation method for a secondary battery according to an example of the present disclosure, the anode reversible capacity of the secondary battery may be 400 mAh/g or more.

In a formation method for a secondary battery according to an example of the present disclosure, the secondary battery may comprise a silicon-based material as an anode active material.

In a formation method for a secondary battery according to an example of the present disclosure, at least any one step may be performed under a pressure condition exceeding 800 kgf/cm³ and less than or equal to 2000 kgf/cm³.

In a formation method for a secondary battery according to an example of the present disclosure, at least any one step may be performed under a temperature condition of 30 to 70° C.

In a formation method for a secondary battery according to an example of the present disclosure, the anode reversible capacity of the secondary battery may be 400 mAh/g or more.

In a formation method for a secondary battery according to an example of the present disclosure, at least any one step may be performed under a temperature condition of 30 to 70° C.

In a formation method for a secondary battery according to an example of the present disclosure, at least any one step may be performed under a pressure condition exceeding 800 kgf/cm³ and less than or equal to 2000 kgf/cm³.

A secondary battery according to another example of the present disclosure may be formed by the formation method.

According to an aspect of the present disclosure, the formation method for a secondary battery can omit the initial formation step of charging to less than a SOC of 3%.

According to another aspect of the present disclosure, it is possible to reduce the volume expansion of the anode and form the dense interface when the formation method for a secondary battery is applied to the secondary battery having an anode reversible capacity of 400 mAh/g or more. According to the formation method for a secondary battery according to an example of the present disclosure, it is possible to improve the cell appearance and durability of the secondary battery having the anode reversible capacity of 400 mAh/g or more. According to the formation method for a secondary battery according to an example of the present disclosure, it is possible to secure the cell performance of the secondary battery having the anode reversible capacity of 400 mAh/g or more.

Still another aspect of the present disclosure, the formation method for a secondary battery may reduce the volume expansion of the anode and form the dense interface when applied to the secondary battery comprising the silicon-based material as the anode active material. According to the formation method for a secondary battery according to an example of the present disclosure, it is possible to improve the cell appearance and durability of the secondary battery comprising the silicon-based material as the anode active material. According to the formation method for a secondary battery according to an example of the present disclosure, it is possible to secure the cell performance of the secondary battery comprising the silicon-based material as the anode active material. According to the formation method for a secondary battery according to an example of the present disclosure, it is possible to suppress the initial volume expansion of silicon and increase the uniformity of the electrode interface.

According to the formation method for a secondary battery according to an example of the present disclosure, it is possible to drastically reduce the process time, making it advantageous for mass production of the secondary battery.

The effects of the present disclosure are not limited to those mentioned above, and other effects not mentioned can be clearly understood by those skilled in the art from the following description.

It would be obvious to those skilled in the art that the present disclosure can be modified within the scope of the disclosed technical idea. The described examples should be viewed as part of the present disclosure, and the scope of the present disclosure should not be limited only through the described examples.

The scope of the present disclosure should be judged by the technical idea described in the claims. In addition, even if the actions or effects according to the configuration are not explicitly described while describing the examples of the present disclosure, it is obvious that the actions or effects that are predictable by the configuration should be recognized as the present disclosure.

1. A formation method for a secondary battery with an anode reversible capacity of at least 400 mAh/g, the method comprising:
charging the secondary battery to a first state of charge (SOC) of 3 to 10% at a first rate of 0.1 to 0.5 C;
charging the secondary battery from the first SOC to a second SOC of 20 to 40% at a second rate of 0.3 to 1.8 C;
charging the secondary battery from the second SOC to a third SOC of 100% at a third rate of 0.05 to 1.8 C; and
discharging the secondary battery charged to the third SOC.

2. The formation method of claim 1, wherein the charging of the secondary battery to the first SOC is not performed after charging of the secondary battery toto a fourth SOC of less than 3% at a fourth rate.

3. The formation method of claim 1, wherein the charging of the secondary battery to the first SOC, the charging of the secondary battery to the second SOC, the charging of the secondary battery to the third SOC, and the discharging of the secondary battery are performed under a pressure condition exceeding 800 kgf/cm³ and less than or equal to 2000 kgf/cm³.

4. The formation method of claim 1, wherein the charging of the secondary battery to the first SOC, the charging of the secondary battery to the second SOC, the charging of the secondary battery to the third SOC, and the discharging of the secondary battery are performed under a pressure condition exceeding 1000 kgf/cm³ and less than or equal to 1800 kgf/cm³.

5. The formation method of claim 1, wherein the charging of the secondary battery to the first SOC, the charging of the secondary battery to the second SOC, the charging of the secondary battery to the third SOC, and the discharging of the secondary battery are performed under a temperature condition of 30 to 70° C.

6. The formation method of claim 1, wherein the charging of the secondary battery to the first SOC, the charging of the secondary battery to the second SOC, the charging of the secondary battery to the third SOC, and the discharging of the secondary battery are performed under a temperature condition of 45 to 60° C.

7. The formation method of claim 1, wherein a rate of the discharging is the same as a maximum of the third rate.

8. The formation method of claim 1, wherein the secondary battery comprises a silicon-based material as an anode active material.

9. The formation method of claim 1, wherein the third rate is 1.5 C.

10. A formation method for a secondary battery, the formation method comprising at least one of:
charging the secondary battery at a pressure exceeding 800 kgf/cm³ and less than or equal to 2000 kgf/cm³; or
discharging the secondary battery at a pressure exceeding 800 kgf/cm³ and less than or equal to 2000 kgf/cm³.

11. The formation method of claim 10, wherein the at least one of the charging or the discharging is performed under a temperature condition of 30 to 70° C.

12. The formation method of claim 10, wherein an anode reversible capacity of the secondary battery is 400 mAh/g or more.

13. The formation method of claim 10, wherein the formation method comprises the charging of the secondary battery at the pressure, wherein the charging of the second battery comprises:
charging the secondary battery to a first state of charge (SOC) of 3 to 10% at a first rate of 0.1 to 0.5 C;
charging the secondary battery from the first SOC to a second SOC of 20 to 40% at a second rate of 0.3 to 1.8 C; and
charging the secondary battery from the second SOC to a third SOC of 100% at a third rate of 0.05 to 1.8 C.

14. A formation method for a secondary battery, the formation method comprising at least one of:
charging the secondary battery at a temperature of 30 to 70° C.; or
discharging the secondary battery at a temperature of 30 to 70° C.

15. The formation method of claim 14, wherein the at least one of the charging or the discharging is performed under a pressure exceeding 800 kgf/cm³ and less than or equal to 2000 kgf/cm³.

16. The formation method of claim 14, wherein an anode reversible capacity of the secondary battery is 400 mAh/g or more.

17. The formation method of claim 14, wherein the formation method comprises the charging of the secondary battery at the temperature, wherein the charging of the second battery comprises:
charging the secondary battery to a first state of charge (SOC) of 3 to 10% at a first rate of 0.1 to 0.5 C;
charging the secondary battery to a second SOC of 20 to 40% at a second rate of 0.3 to 1.8 C; and
charging the secondary battery to a third SOC of 100% at a third rate of 0.05 to 1.8 C.

18. A secondary battery formed by the formation method of claim 1.

19. The secondary battery of claim 18, wherein the secondary battery comprises an anode comprising:
silicon as an anode active material.

20. The secondary battery of claim 18, wherein the anode further comprises:
a conductive material;
a binder, and
a thickener.
